(19) United States
(12) Patent Application Publication
(10) Pub. No.: US 2006/0089010 A1
(43) Pub. Date: Apr. 27, 2006

(54) Connector assembly

(76) Inventor: Jung-Wen Chang, Lu Chu Hsiang (TW)

Correspondence Address: RABIN & BERDO, P.C., Suite 500, 1101 14 Street, N.W., Washington, DC, 20005, US

(21) Appl. No.: 11/123,073

(22) Filed: May 6, 2005

(30) Foreign Application Priority Data
Oct. 26, 2004 (TW) 93217020

(51) Int. Cl. H01R 12/00

(52) U.S. Cl. 439/64

(57) ABSTRACT

A connector assembly includes a plurality of connectors packed together. Plug surfaces of connectors can either be arranged on one side or on two opposite sides. The connector assembly can have a plurality of connectors manufactured in one housing. The plug surfaces on the same side can be positioned on one surface or on different surfaces.

### RELATED APPLICATIONS

The present application is based on, and claims priority from, Taiwan Application Serial Number 93217020, filed Oct. 26, 2004, the disclosure of which is hereby incorporated by reference herein in its entirety.

### BACKGROUND

1. Field of Invention

The present invention relates to a connector assembly. More particularly, the present invention relates to a connector assembly adapted for portable electronic devices.

2. Description of Related Art

A portable electronic device needs several peripherals in order to operate properly. For instance, a notebook computer necessitates a hard disk to store data and a battery to supply power. The notebook computer, only equipped with a motherboard and a central processing unit, if cannot function. Many connectors adapted for the notebook computer are coupled to essential peripherals.

Only one connector is available for one kind of essential peripheral in a conventional notebook computer because of size and weight constraints.

As the manufacturing technology of the notebook computer advances, many essential peripherals can be designed thinner and lighter than prior designs. In some applications, the portable electronic device may need more than one peripheral for the same function. For instance, a portable electronic video device may need two or three hard disks to store many media files.

For the foregoing reasons, the portable electronic device needs another connector to couple to a second or third hard disk, which will occupy more space and cost more.

### SUMMARY

It is therefore an objective of the present invention to provide a connector assembly so that the connector assembly can occupy less space and cost less.

In accordance with the foregoing and other objectives of the present invention, a connector assembly includes a plurality of connectors packed together. Plug surfaces of connectors can be arranged on one side or on two opposite sides. The connector assembly can have a plurality of connectors manufactured in one housing. The plug surfaces on the same side can be positioned on one surface or on different surfaces.

Thus, the connector assembly mentioned above can be applied to a portable electronic device so that the connector assembly can occupy less space and cost less.

It is to be understood that both the foregoing general description and the following detailed description are by examples and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 illustrates a perspective view of a connector assembly according to one preferred embodiment of this invention;

FIG. 2 illustrates a perspective view of a connector assembly application according to one preferred embodiment of this invention;

FIG. 3 illustrates a perspective view of a connector assembly according to another preferred embodiment of this invention; and

FIG. 4 illustrates a perspective view of a connector assembly application according to another preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to equip a portable electronic device with more than one peripheral of the same function, the present invention provides a connector assembly to connect with more peripherals of the same function such that the connector assembly can occupy less space and cost less.

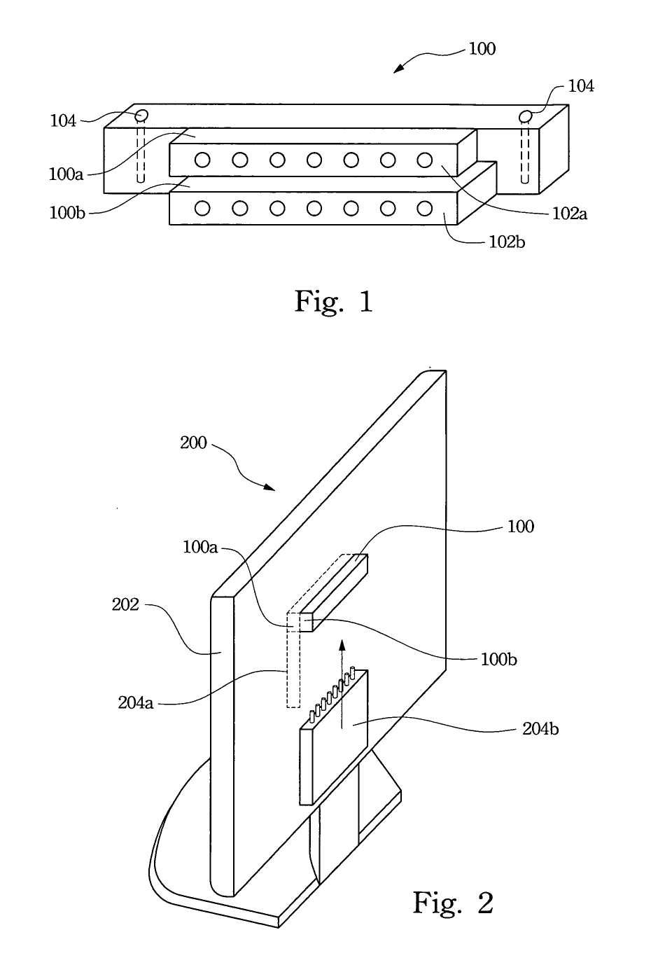

FIG. 1 illustrates a perspective view of a connector assembly according to one preferred embodiment of this invention. A connector assembly 100 includes two connectors 100a and 100b, which are preferably manufactured in one housing. Several screw holes 104 are formed on the connector assembly 100 for securing to a potable electronic device. Two plug surfaces 102a and 102b are arranged on the same side of two connectors 100a and 100b. Two plug surfaces 102a and 102b can either form a single surface or separate surfaces. If each plug surface forms a separate surface, a peripheral can be easily plugged into a correct plug surface. Although this preferred embodiment only illustrates a connector assembly with two connectors, it can be expanded to more than two connectors.

FIG. 2 illustrates a perspective view of a connector assembly application according to one preferred embodiment of this invention. The connector assembly 100 in FIG. 1 is applied in an electronic device 200 including an LCD (liquid crystal display) monitor 202. The electronic device 200 can be an LCD in a personal computer or an LCD television. The LCD monitor 202 includes an LCD panel 202. The connector assembly 100 is designed on a back side of the LCD panel 202, wherein a connector 100a is positioned inside the back side of the LCD panel 202 (illustrated as a dashed line) and a connector 100b is positioned on the back side of the LCD panel 202, which is outside the LCD panel 202. Two connectors 100a and 100b are preferably manufactured in one housing. A hard disk 204a has been plugged into the connector 100a during an assembly procedure. A user can plug a backup hard disk 204b into the connector 100b if necessary.

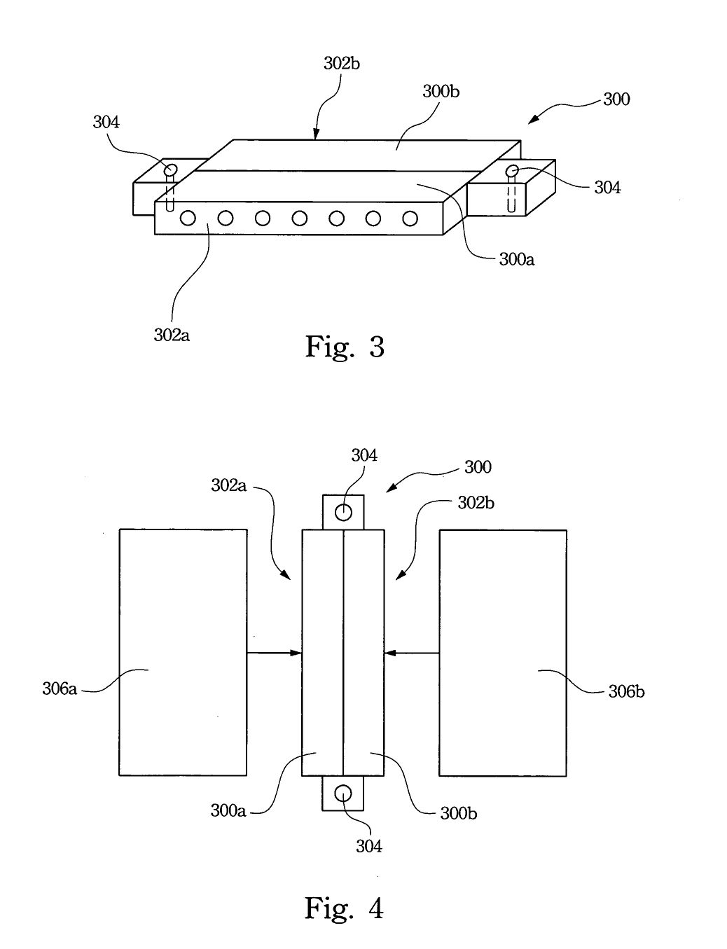

FIG. 3 illustrates a perspective view of a connector assembly according to another preferred embodiment of this invention. A connector assembly 300 includes two connectors 300a and 300b, which are preferably manufactured in one housing. Several screw holes 304 are formed on the connector assembly 300 for securing to a potable electronic device. Two plug surfaces 302a and 302b are arranged on opposite sides of the two connectors 300a and 300b. Although this preferred embodiment only illustrates a connector assembly of two connectors, it can be expanded to four or any even number of connectors. Plug surfaces on one side can either form a single surface or separate surfaces.

FIG. 4 illustrates a perspective view of a connector assembly application according to FIG. 3, another preferred embodiment of this invention. When the connector assembly 300 is secured to a portable electronic device with screw holes 304, two peripherals 306a and 306b can be respectively plugged into the plug surfaces 302a and 302b.

According to above preferred embodiments, a connector assembly can be applied to a portable electronic device such that the connector assembly can occupy less space and cost less.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A connector assembly, comprising a plurality of connectors packed together, said connectors having plug surfaces, said plug surfaces being arranged on the same side of said connectors.

2. The connector assembly of claim 1, wherein each of said plug surfaces, arranged on the same side of said connectors, forms a separate surface.

3. The connector assembly of claim 1, wherein said plug surfaces, arranged on the same side of said connectors, form only one surface.

4. The connector assembly of claim 1, wherein said connectors are manufactured in one housing.

5. A connector assembly, comprising an even number of connectors packed together, said connectors having plug surfaces, said plug surfaces being evenly arranged on opposite sides of said connectors.

6. The connector assembly of claim 5, wherein each of said plug surfaces, arranged on one of two opposite sides of said connectors, forms a separate surface.

7. The connector assembly of claim 5, wherein said plug surfaces, arranged on one of two opposite sides of said connectors, form only one surface.

8. The connector assembly of claim 5, wherein said connectors are manufactured in one housing.

9. An electronic device having an LCD display and a connector assembly, said connector assembly comprising:
a first connector, positioned inside a back side of said LCD display, said first connector having a first plug surface to couple with a first peripheral; and
a second connector, positioned upon said back side of said LCD display, said second connector having a second plug surface to couple with a second peripheral, wherein said first connector and said second connector are packed together in one housing.

10. The electronic device of claim 9, wherein said first plug surface and said second plug surface are arranged on the same side of said first connector and said second connector.

11. The electronic device of claim 9, wherein said first plug surface and said second plug surface are arranged on opposite sides of said first connector and said second connector.
